(19) United States
(12) Patent Application Publication
(10) Pub. No.: US 2008/0268115 A1
(43) Pub. Date: Oct. 30, 2008

(54) Hot Boned Poultry Process

(75) Inventors: Iksoon Kang, Madison, WI (US); Henri Salman, Simpsonville, SC (US); Dennis Seman, Cottage Grove, WI (US); Lyle Olson, Chapin, SC (US)

Correspondence Address: FITCH EVEN TABIN & FLANNERY, 120 S. LASALLE STREET, SUITE 1600, CHICAGO, IL, 60603-3406, US

(73) Assignee: KRAFT FOODS HOLDINGS, INC., Northfield, IL (US)

(21) Appl. No.: 11/740,586

(22) Filed: Apr. 26, 2007

(51) Int. Cl. A23L 1/315

(52) U.S. Cl. 426/332; 426/644

(57) ABSTRACT

The present invention relates to continuous processing of poultry. More particularly, poultry is processed for times and under conditions effective for maintaining the poultry muscle in a pre-rigor condition. hot boned poultry is ground or macerated to provide a ground or macerated poultry meat. The ground or macerated poultry meat is blended with salt and optionally nitrite or/and phosphate to provide a blended ground or macerated poultry meat. Blending is effective for providing a blended ground or macerated poultry meat with about 1.0 to about 3.5 weight percent salt, 0 to 200 ppm nitrite, and about 0 to about 0.5 weight percent phosphate, based on the total weight of the blended ground or macerated poultry meat. The blending is effective for providing a blended ground or macerated poultry meat having a temperature of about 26° F. to about 60° F. and a pH of 5.9 or greater.

The present invention relates to continuous processing of poultry. More particularly, poultry is processed for times and under conditions effective for maintaining the poultry muscle in a pre-rigor condition. Specifically, hot boned muscle or pre-rigor (called hot boned muscle hereafter) is ground or macerated and blending with salt and phosphate in a relatively short continuous processing time within certain temperature and pH ranges.

### BACKGROUND

Present poultry processing methods include the steps of placing the birds on shackles and moving them along a processing path where they are sacrificed, defeathered, eviscerated, washed and directed through water chillers to lower the temperature before being further processed. The whole carcasses pass through a pre-chiller and a post chiller to reduce the body heat of the carcasses to 40° F. or lower. The whole carcasses exit the chillers in a cut-up room where they are separated into parts. Some of the parts go directly to deboning and further processing. The time required to obtain deboned meat may be six hours or more. Once rigor mortis sets in, it is more difficult to extract protein in further processing and may result in less yield. Also, deboning in a rigor phase can result in muscle toughening when the product is frozen and subsequently cooked.

Hot boning methods have been known to be beneficial in processing meats such as beef and pork. However, hot boning techniques have not been adopted in the processing of poultry, which is due to the rapid rigor onset which is experienced in poultry muscle.

### SUMMARY

A continuous process for poultry meat is provided that is effective for producing a poultry meat with desirable organoleptic properties. More specifically, poultry meat processed in accordance with the processes described herein has a high water holding capacity resulting in reduced purge during/after cook Further, meat processed in accordance with the processes described herein were effective for forming a processed meat slice having a shear force of at least 10 lb/0.1 inch, preferably about 15 lb/0.1 inch to about 20 lb/0.1 inch): Shear force was measured by a 5 blade shear device from each single, which was sliced by 0.05″ thickness. Since the process is continuous, poultry meat can be processed as it becomes available. The continuous process allows for quicker (pre-rigor processing) and provides savings in terms of equipment space and operating costs as compared to batch processing.

A continuous process is provided for processing poultry. The process includes providing a hot boned poultry meat having a temperature of about 90° F. to about 105° F. and a pH of about 6 to about 7. The hot boned poultry is ground or macerated to provide a ground or macerated poultry meat. The ground or macerated poultry meat is blended with salt and optionally nitrite or/and phosphate to provide a blended ground or macerated poultry meat. Blending is effective for providing a blended ground or macerated poultry meat with about 1.0 to about 3.5 weight percent salt, 0 to 200 ppm nitrite, and about 0 to about 0.5 weight percent phosphate, based on the total weight of the blended ground or macerated poultry meat. The blending is effective for providing a blended ground or macerated poultry meat having a temperature of about 26° F. to about 60° F. and a pH of 5.9 or greater.

In another aspect, a continuous poultry process is provided that includes adding ground or macerated poultry to a blending means at a rate of about 10,000 to about 30,000 pounds per hour. Salt (1-3.5%) is added to the blending with an option of nitrite/nitrate (0 to 200 ppm) and phosphate (0 to 0.5%) based on the total weight of blended meat. The blending means is maintained at a temperature of about 26 to about 60° F. with ice, liquid nitrogen or carbon dioxide, or combination of those.

Poultry which may be processed includes turkey, chicken, duck, goose, guinea hen and the like. Processing may be conducted with salts that include NaCl and KCl, and with or without nitrite/nitrate, and phosphates that include sodium phosphate and potassium phosphate.

### BRIEF DESCRIPTION OF THE DRAWINGS

FIG. 1 generally illustrates a continuous poultry processing method. Time are those times for processing poultry by current processes and deboning by one person.

FIG. 2 shows textures of turkey breast made with chilled, warm or hot deboned turkey.

### DETAILED DESCRIPTION

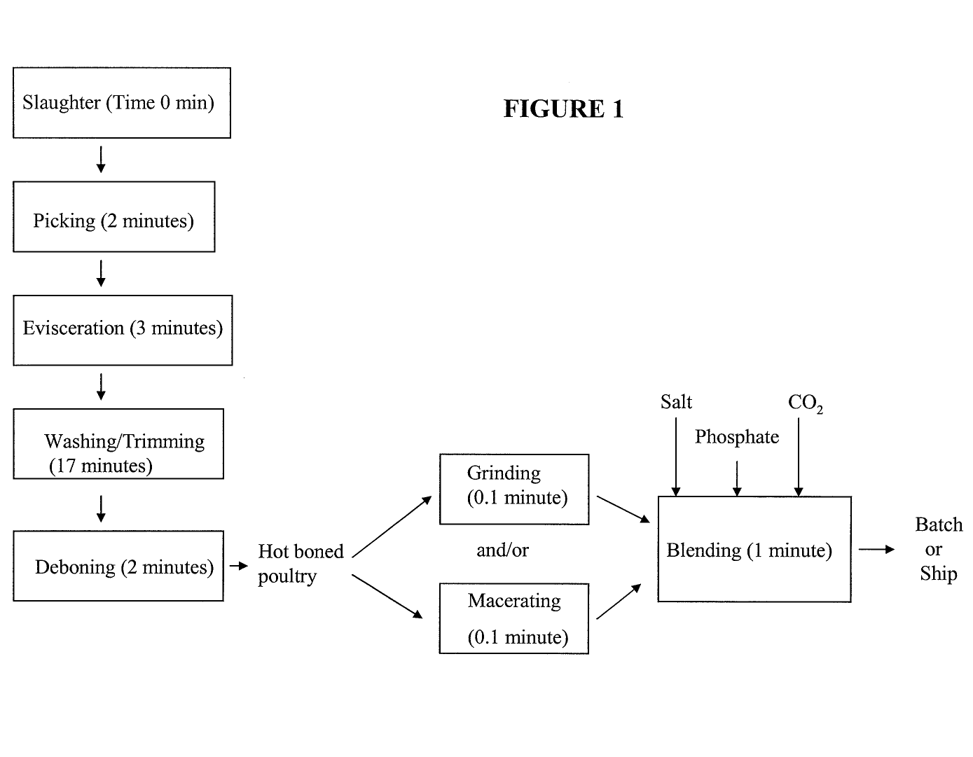

A continuous poultry processing method is generally illustrated in FIG. 1. In accordance with the process poultry is slaughtered, picked, eviscerated and washed such that the time from slaughter to deboning is not more than about 60 minutes, and preferably is about 20 to about 45 minutes. Poultry is deboned to provide a hot-boned poultry meat. The hot-boned poultry is ground and/or macerated. The ground and/or macerated poultry is then blending with salt, and optionally nitrite or phosphate with a chilling agent such as liquid nitrogen or CO₂. The resulting product may then be batched, stored and/or shipped. In an important aspect, ground or macerated poultry may be processed at a rate of about 5,000 to about 30,000 lbs, more preferably about 10,000 to about 30,000 lbs of ground or macerated poultry meat per hour.

Not only does the process conserve time and energy since the whole carcass does not have to be frozen or chilled, but it offers great flexibility in processing. For example, hot boned parts (breast, thigh or wing) may be chilled and batched immediately, may be chilled, preblended with key spices (salt, nitrite or phosphate) and frozen for a long storage; may be chilled and preblended to ship to other plants; or just chilled the muscles without being prebleded.

### Hot Boned Poultry Meat

As used herein, “hot boned poultry meat” refers to poultry meat that is debonded and removed from the animal carcass while it is still close to body temperature and before the muscle develops rigor mortis. Poultry that may be used includes turkey, chicken, duck, goose, guinea hen and the like. Slaughtering methods know in the art may used.

In an important aspect, the hot boned poultry meat is removed from the carcass soon after slaughter. In this aspect, muscle is removed from the carcass within about 60 minutes after slaughter, preferably within about 30 minutes or less after slaughter, and is an important aspect within about 20 minutes or less after slaughter. Quick removal of muscle from the carcass is effective for maintaining a muscle temperature of about 90° F. to about 105° F. and at a pH of about 6.0 to about 7.0. Processing of the muscle at these times, temperatures and pH levels is effective for preventing the development of rigor mortis in the muscle.

### Grinding or Macerating

Grinding or macerating is conducted in manner effective for extracting muscle protein, reducing muscle temperate and to provide a well emulsified batter. Grinding or macerating may also be effective for evenly dispersing salts and/or other seasonings which may be optionally added to the muscle. Grinding or macerating may be modified to provide a desired appearance and texture for a desired end product.

Grinding or macerating may be conducted by method and with equipment known in the art. For example, grinding may be conducted in a grinder (Weiler) with various plate sizes or maceration may be conducted in an Oscar Mayer Macerator with various gap/overlap (manufactured by General Motor Development).

### Blending and Chilling

The ground or macerated hot boned muscle is blended with salt, and an optional curing agent and phosphate. The blending with salt and phosphate in a pre-rigor condition is more effective for extracting salt soluble proteins from muscle than extractions conducted in a post-rigor condition. In this aspect, the resulting protein is more functional and has better texture than muscle extracted in a post-rigor condition. This results in a finished product in which the meat pieces are more firmly bound together and upon slicing won't fall apart. Also, more of the natural meat juices are trapped in the product which results in a more moist product with higher yield.

The amount of salt (sodium chloride or potassium chloride) blended with the ground or macerated hot boned turkey muscle is dependent upon desired texture firmness, and taste and flavor requirements. Generally, salt is blended to provide a total concentration of about 1.0 to about 3.5 weight percent, preferably about 1.0 to about 3.0 weight percent, based on the total weight of the blend.

In an important aspect, the ground or macerated hot boned muscle is chilled to a temperature of about 26 to about 60° F. Chilling may be accomplished by blending the ground or macerated hot boned muscle directed with dry ice (CO₂), ice, cold brine, liquid nitrogen, and or gaseous nitrogen. Alternatively, blending may be conducted in a refrigerated blender having a temperature setting of from about 26 to about 60° F. at the exit. Blending may be conducted in the refrigerated blend in combination with blending dry ice, liquid nitrogen, gaseous nitrogen, gaseous CO₂ or other cryogenic agents.

Optional curing agents that may be added include salt and sodium nitrate/nitrite. In cure, both forms of nitrate, sodium nitrate (NaNO₃) and sodium nitrite (NaNO₂) usually co-existing and amounts are expressed by the use of nitrites, nitrates or combinations. In this aspect, when nitrates are utilized they may be present in an amount of from more than 0 to about 200 ppm, preferably about 120 ppm to about 200 ppm, and most preferably about 156 ppm.

Phosphates may be utilized in amounts effective for providing a firm texture (not soft or mushy texture). Phosphates may be present in an amount of from more than about 0 to about 0.5 weight percent, preferably about 0.4 weight percent to about 0.5 weight percent, based on the total weight of the blend.

### EXAMPLES

The following examples further illustrate various features of the invention, but are not intended to limit the scope of the invention as set forth in the appended claims. Unless otherwise noted, all percentages and ratios are by weight. All references cited in the present specification are hereby incorporated by reference.

### Example 1

### Continuous Processing of Hot Bone/Pre-Rigor Turkey

Temperature and pH progression during turkey processing was as follows:

| Processing Step | Temp (° F.)* | pH* | Time (min) |
|---|---|---|---|
| Sticking | N/A | N/A | 0 (0) |
| Picking | 110 | 6.6 | 2 (2) |
| Evisceration | 108 | 6.5 | 5 (3) |
| Washing | 106 | 6.4 | 22 (17) |
| Pre-chill | 103 | 6.36 | 30 (8) |
| Post-chill | 85 | 6.21 | 70 (42) |
| Deboning (7,000# breast) | N/S | N/A | 102 (30) |
| CO₂ blend (7,000# breast) | 39 | 6.1 | 182 (50) |

*Average breast temperature/
*Average breast pH

Time is accumulated time from the moment of sticking, and number in parenthesis is the time (min.) required in the step. About 2-3 minutes are required to debone a breast per bird by one person.

Turkey breast was prepared from poultry in accordance with this example both in a pilot plant and in plant test runs. The texture of turkey breast made with chilled, warm or hot boned muscle was determined using a 5 blade shear device described previously. Samples were sliced by 0.05″ thickness and 10 readings from 10 slices at random were measured. Each reading in the table represents the average of 10 measurements. Results were as follows.

| | Shear Force | | |
|---|---|---|---|
| | (lb/0.1 in) | | |
| Test | CB | WB | HB |
| Pilot Plant (ground, chilled) | 17.9 | — | 18.7 |
| Pilot Plant (macerated, chilled) | 17.7 | — | 17.3 |
| Plant (ground, not chilled) | 16.0 | — | 11.3 |
| Plant (ground, chilled) | 12.7 | 12.7 | — |
| Pilot Plant (ground, chilled) | 13.5 | 13.1 | 15.5 |

Chill boned (CB), warm boned (WB) and hot boned (HB) breasts were prepared by deboning the muscle when the carcass temperatures were chilled to lower than 40° F., about 80° F. and about 98° F., respectively.

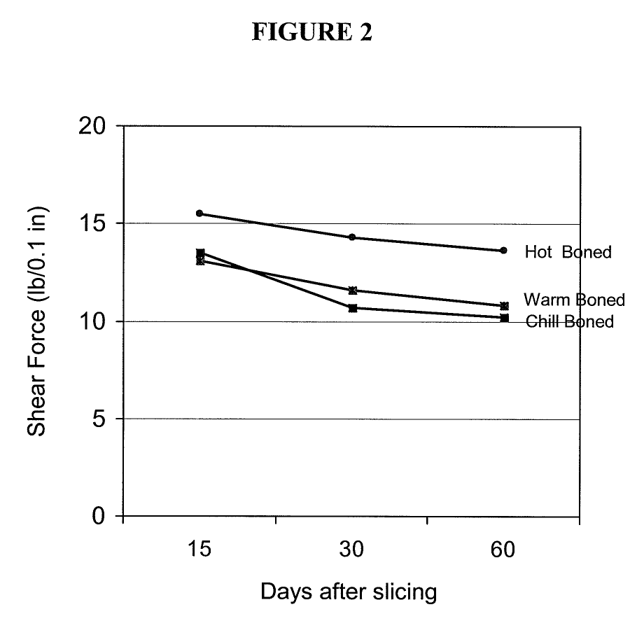

The texture of turkey breast made with chilled, warm or hot deboned turkey is described graphically in FIG. 2.

What is claimed is:

1. A continuous process for processing poultry, the process comprising:
providing a hot boned poultry meat having a temperature of about 90° F. to about 105° F. and a pH of about 6 to about 7;
grinding or macerating hot boned poultry meat to provide a ground or macerated poultry meat; and
blending the ground or macerated poultry meat with salt, the blending effective for providing a blended ground or macerated poultry meat with about 1.0 to about 3.5 weight percent salt, based on the total weight of the blended ground or macerated poultry meat, wherein the blending is effective for providing a blended ground or macerated poultry meat having a temperature of about 28° F. to about 60° F. and a pH of 5.9 or greater.

2. The process of claim 1 wherein from about more than 0 to about 200 ppm nitrite and more than 0 to about 0.5 weight percent phosphate, based on the total weight of the blended ground or macerated poultry meat, are further blended with the ground or macerated poultry meat.

3. The process of claim 1 wherein the poultry is selected from the group consisting of turkey, chicken, duck, goose and guinea hen.

4. The process of claim 1 wherein the salt is selected from the group consisting of NaCl and KCl.

5. The process of claim 2 wherein the phosphate is selected from the group consisting of sodium phosphate and potassium phosphate.

6. The process of claim 1 wherein the ground or macerated poultry is refrigerated or blended with ice, dry ice, liquid nitrogen or gaseous nitrogen in an amount effective for providing a blended ground or macerated poultry meat with a temperature of about 28° F. to about 60° F.

7. The process of claim 1 wherein the ground or macerated poultry is processed at a rate of about 5,000 to about 30,000 lbs of ground or macerated poultry meat per hour.

8. A continuous poultry process comprising:
adding ground or macerated poultry to a blending means at a rate of about 10,000 to about 30,000 pounds per hour;
adding salt at a rate effective for providing a blend with about 1.0 to about 3.5 percent salt, based on the total weight of the blended ground or macerated poultry meat, and
maintaining the blending means at a temperature of about 28 to about 60° F.

9. The process of claim 1 wherein nitrite and phosphate are blended with the ground or macerated poultry meat in amounts effective for providing a ground or macerated poultry meat with from about more than 0 to about 200 ppm nitrite and more than 0 to about 0.5 weight percent phosphate, based on the total weight of the blended ground or macerated poultry meat.

10. The process of claim 8 wherein the poultry is selected from the group consisting of turkey, chicken, duck, goose and guinea hen.

11. The process of claim 8 wherein the salt is selected from the group consisting of NaCl and KCl.

12. The process of claim 8 wherein the phosphate is selected from the group consisting of sodium and potassium phosphate.

13. The process of claim 8 wherein the temperature of the blending means is maintained by adding ice, dry ice, liquid nitrogen or gaseous nitrogen, gaseous CO₂, or other cryogenic agents to the blending means.

14. The process of claim 8 wherein the temperature of the blending means is maintained with refrigeration external to the blending means.

15. A ground or macerated poultry meat prepared by a process comprising:
providing a hot boned poultry meat having a temperature of about 90 to about 105 F. and a pH of about 6 to about 7;
grinding or macerating hot boned poultry meat to provide a ground or macerated poultry meat; and
blending the ground or macerated poultry meat with salt, based on the total weight of the blended ground or macerated poultry meat, wherein the blending is effective for providing a blended ground or macerated poultry meat having a temperature of about 28 to about 60° F. and a pH of 5.9 or greater.

16. The poultry meat of claim 15 wherein nitrite and phosphate are blended with ground or macerated poultry meat in amounts effective for providing a ground or macerated poultry meat with from about more than 0 to about 200 ppm nitrite and more than 0 to about 0.5 weight percent phosphate, based on the total weight of the blended ground or macerated poultry meat.

17. The poultry meat of claim 15 wherein the poultry is selected from the group consisting of turkey, chicken, duck, goose and guinea hen.

18. The poultry meat of claim 15 wherein the salt is selected from the group consisting of NaCl and KCl.

19. The poultry meat of claim 15 wherein the phosphate is selected from the group consisting of sodium and potassium phosphate.

20. The poultry meat of claim 15 wherein the ground or macerated poultry is refrigerated or blended wit ice, dry ice, liquid nitrogen or gaseous nitrogen in an amount effective for providing a blended ground or macerated poultry meat with a temperature of about 28° F. to about 60° F.

21. The poultry meat of claim 15 wherein the ground or macerated poultry is processed at a rate of about 5,000 to about 30,000 lbs of ground or macerated poultry meat per hour.

22. A process poultry slice prepared with the ground or macerated poultry of claim 15, wherein the poultry slice has a shear force of at least about 10 lbs/0.1 inch.
